(19) United States
(12) Patent Application Publication
(10) Pub. No.: US 2011/0106733 A1
(43) Pub. Date: May 5, 2011

(54) SYSTEM AND METHOD FOR PATIENT-MANAGED ORAL ANTICOAGULANT THERAPY

(76) Inventors: Pavel Roshanov, Niagara Falls (CA); Noemi Chanda, Toronto (CA)

(21) Appl. No.: 12/609,380

(22) Filed: Oct. 30, 2009

(51) Int. Cl. G06F 15/18; G06N 5/02

(52) U.S. Cl. 706/12; 706/54

(57) ABSTRACT

A system for facilitating patient-managed anticoagulant therapy having patient portals for receiving patient information associated with a current case. Each patient portal has a patient portal processor, patient portal memory, and an output device, and the patient information including current factors affecting patient reaction to anticoagulant therapy. The system also has a case repository connected to each patient portal, the case repository having a case repository processor and a case repository memory storing previous cases, each case having previous factors affecting patient reaction to anticoagulant therapy and at least one solution. The patient portal processor and/or the case repository processor are programmed for selecting at least one relevant case similar to the current case and provide the solution to that case for application to the current case. A similarity metric is applied to each previous case to determine the similarity of each previous case to the current case.

### FIELD

The present invention relates to the field of health care management, and in particular to a system and method for patient-managed oral anticoagulant therapy.

### INTRODUCTION

Stroke and myocardial infarction are major causes of mortality and morbidity today. Anticoagulation therapy is used in preventing these events by lowering the blood's efficiency in forming dangerous blood clots. The Vitamin K antagonist warfarin-sodium (hereinafter referred to as “warfarin”) is an anticoagulant agent used for long-term therapy. Warfarin is used to prevent the formation of dangerous blood clots and subsequent blockage of blood vessels in people with a history of deep venous thrombosis, pulmonary embolism, chronic atrial fibrillation, and those who have prosthetic heart valves.

Warfarin affects clotting tendency of blood in a patient's body. Blood-clotting efficiency is measured by International Normalized Ratio (INR) value, and the desired therapeutic range is generally between the INR values 2-3. Blood with a low INR value suggests a higher risk of clotting, while a high INR suggests a higher risk of bleeding. Both events are dangerous and are made less probable by maintaining the blood INR value within the therapeutic range.

Responses to warfarin greatly differ between patients. A number of physiological, genetic, and dietary factors interact with the anticoagulant agent to determine the response elicited by an administered dose. A given dose may be too low to elicit the necessary effect in one patient, while being high enough to cause bleeding in another patient. To help adjust the anticoagulant agent dosage for patients, the health care community has devised general rules and guidelines to help with dose adjustment, and some of these have even been embodied in decision support systems. These decision support systems derive general rules/guidelines from the research literature and expert opinions and attempt to apply these rules/guidelines to future patients. However, reasoning based on rules/guidelines may be too rigid and ineffective when the relationship between a constellation of personal attributes and the final outcome is unclear and when many exceptions exist.

To determine correct dosage for a patient, it is often necessary for a patient to seek advice of a health care provider qualified to prescribe a dosage and subsequent adjustments to the dosage. This process may require several visits to health care providers for dosage adjustments before a correct dosage to maintain the therapeutic value is maintained. Additionally, changes in factors effecting a patient's reaction to the anticoagulant agent may change effectiveness of the prescribed dosage. For example, if the patient's diet changes, it might require further adjustments to the dosage to maintain INR values within the therapeutic INR range. It may also be desirable to periodically monitor the blood INR value and if necessary, adjust the dosage of the anticoagulant agent. The periodic monitoring may necessitate further visits to a health care provider.

Accordingly, there is a need for improved decision support for determining anticoagulant therapy for a patient that addresses at least one of the shortcomings in existing decision support systems and guidelines.

### SUMMARY

The invention provides in one aspect, computer implemented method for patient-managed anticoagulant therapy using a processor and a memory, the method comprising: receiving patient information associated with a current case, the patient information including at least one current factor affecting patient reaction to anticoagulant therapy; selecting at least one relevant case similar to the current case from at least one case repository, the case repository comprising at least one previous case; each previous case having at least one previous factor affecting patient reaction to anticoagulant therapy and at least one solution; and providing the at least one solution of the at least one relevant case for application to the current case.

The invention provides in another aspect, a system for facilitating patient-managed anticoagulant therapy comprising: at least one patient portal for receiving patient information associated with a current case, the at least one patient portal including at least one patient portal processor, a patient portal memory, and at least one output device, and the patient information including at least one current factor affecting patient reaction to anticoagulant therapy. The system further comprises at least one case repository connected to the patient portal, the at least one case repository including a case repository processor and a case repository memory, the case repository memory containing at least one previous case, each previous case including at least one previous factor affecting patient reaction to anticoagulant therapy and at least one solution. The at least one of the patient portal processor and the case repository processor is programmed for selecting at least one relevant case similar to the current case from the at least one previous case in the case repository memory, and providing the at least one solution of that at least one relevant case to the at least one output device of the patient portal for application to the current case.

Further aspects and advantages of the embodiments described herein will appear from the following description taken together with the accompanying drawings.

### DRAWINGS

For a better understanding of the embodiments described herein and to show more clearly how they may be carried into effect, reference will now be made, by way of example only, to the accompanying drawings which show at least one example embodiment, and in which:

FIG. 1 is schematic representation of a system for facilitating patient-managed anticoagulant therapy according to one embodiment;

FIG. 2 is a schematic representation of the patient portal shown in FIG. 1;

FIG. 3 is a schematic representation of the case repository shown in FIG. 1;

FIG. 4 is a schematic representation of the health care provider portal shown in FIG. 1;

FIG. 5 is a schematic representation of the server shown in FIG. 1;

FIG. 6 is a flowchart illustrating the steps of a computer-implemented method for patient-managed anticoagulant therapy according to one embodiment; and

FIG. 7 is a flow schematic representation of a system for facilitating patient-managed anticoagulant therapy according to another embodiment.

A person skilled in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or other storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

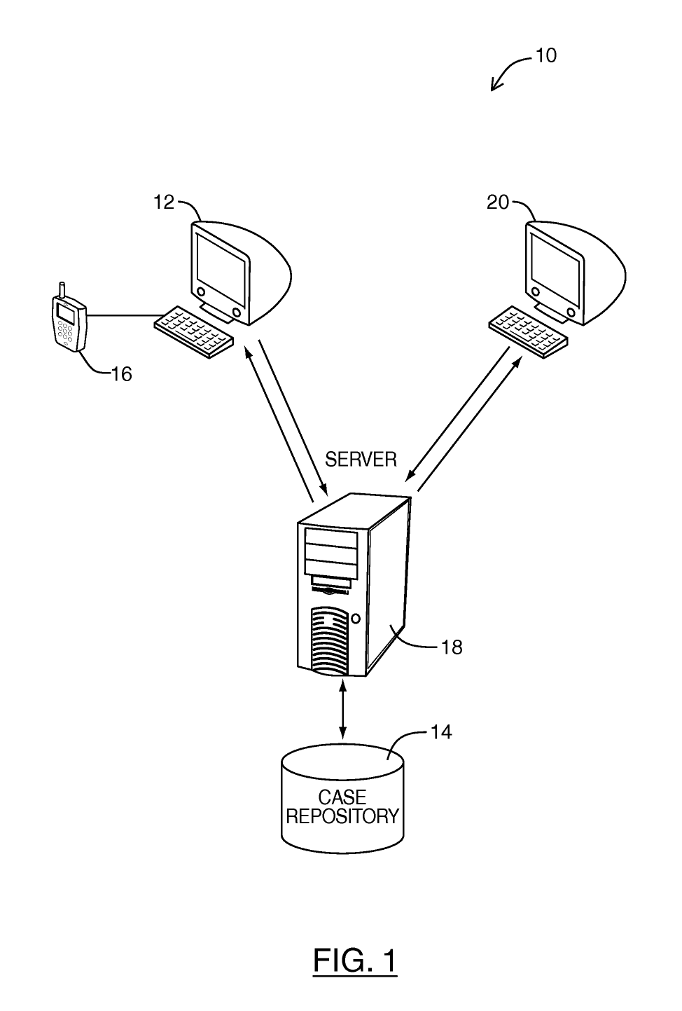

Referring to FIG. 1, provided therein is a system 10 for facilitating patient-managed anticoagulant therapy according to one exemplary embodiment. The system 10 comprises a patient portal 12, a case repository 14, an INR tester 16, a server 18 and a health care provider portal 20. In the current embodiment, the patient portal 12, and the health care provider portal 20 are connected to each other over the Internet. The patient portal 12 and the health care provider portal 20 are also connected to the case repository 14 via the server 18. An output of the INR tester 16 may be electronically or manually provided to the patient portal 12.

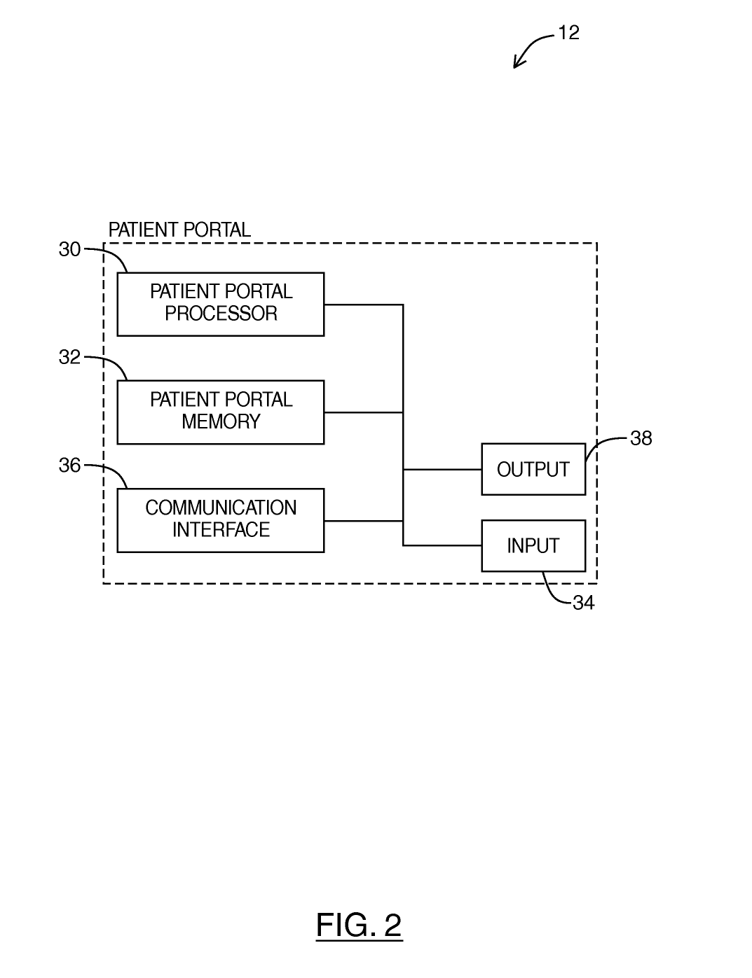

Referring now to FIG. 2, illustrated therein are components of an exemplary patient portal 12 for receiving patient information associated with a current case. The patient portal 12 comprises a patient portal processor 30, a patient portal memory 32, a patient portal input device 34, a patient portal communication interface 36 and a patient portal output device 38. The components of the patient portal 12 are operatively connected to one another.

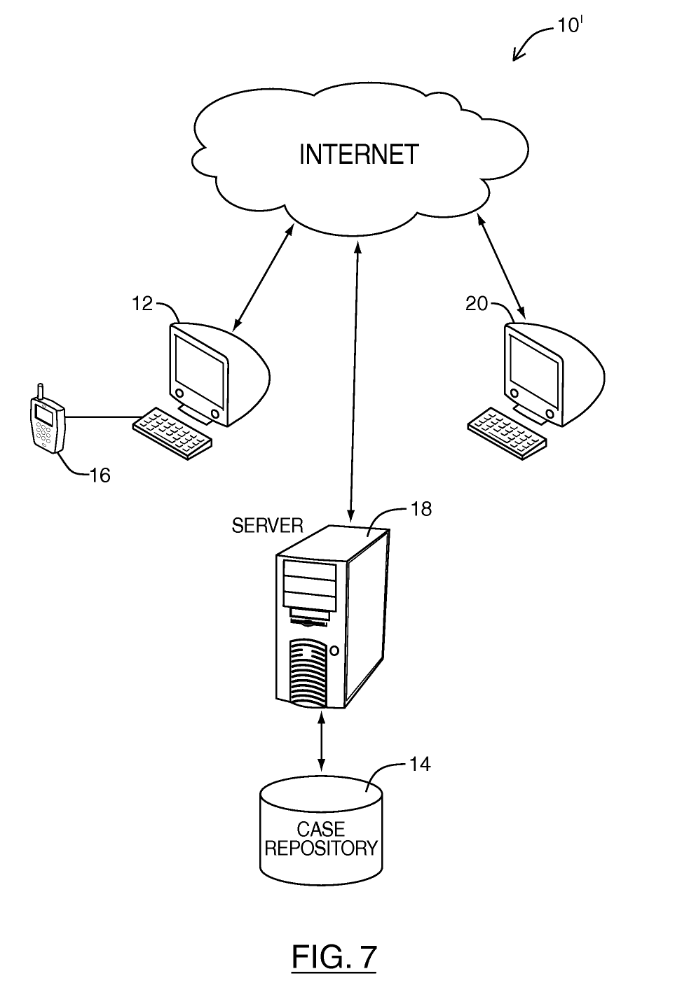

The patient portal processor 30 may be located remotely from the patient portal memory such that the processing of information is performed remotely from the patient portal memory 32. For example, the patient portal 12 may be a web-browser and the patient portal processor 30 may be located remotely over a wide area network. Similarly, the patient portal memory 32 may be located remotely, and data from the patient portal memory 32 may be transmitted through the patient portal communication interface 36 prior to processing. In yet another example, the patient portal 12 may be a web browser connecting remotely to the case repository 14 over the Internet (shown as 10′ in FIG. 7).

The patient portal output device 38 could be a display device such as a screen capable of displaying information. It could also be a printer that is capable of printing out information such that a secondary copy of the information may be produced for easier future reference. The patient portal output device 38 may also be any other hardware, software or a combination of hardware and software that is capable of communicating information to a user of the patient portal 12.

The patient portal communication interface 36 could be a cellular modem, a wireless modem, a wired interface including a USB interface or a combination of software and hardware interface capable of facilitating communication to at least one other component in the system. In the embodiment as shown, the patient portal communication interface 36 facilitates access to the Internet for communication with the server 18 and the health care provider portal 20. In other embodiments, a USB interface may be used to upload or download data from the patient portal 12.

The patient portal 12 further comprises patient portal input device 34 to input information to the patient portal 12 to be stored in patient portal memory 32 and/or to be processed by patient portal processor 30. Some exemplary input devices include keypads, keyboards and touch sensitive surfaces. In some embodiments, wherein the information is inputted to the patient portal 12 electronically, the patient portal communication interface 36 may also function as the patient portal input device 34. For example, a health care provider may wish to input information to the patient portal 12 over the Internet through the patient portal communication interface 36.

The patient portal 12 is accessible to a patient who is desirous of obtaining a correct dosage of anticoagulant agent to maintain the patient's blood INR level within a therapeutic range. The term “patient” used herein may refer to the subject of the anticoagulant therapy (i.e. the actual patient) or any other individual assisting the subject. The therapeutic range is generally between the INR values 2-3. While the current embodiment has been described as attempting to maintain the INR values between 2-3, it may also be used to adjust the dosage to obtain any other desired INR value range. The anticoagulant agent described herein refers to orally administered vitamin K antagonist warfarin-sodium, commonly referred to as “warfarin”. However, other types of anticoagulant agents and/or therapy may be applied in other embodiments.

The patient information received by the patient portal 12 may include various factors that may affect the patient's reaction to anticoagulant therapy. These factors may include: age, weight, height, ethnicity, use of liver enzyme inducing agents, sulfonamide antibiotics, macrolide antibiotics, amiodarone, statins, antiplatelet medications, smoking, genetic information, quantity of alcohol consumption, frequency of alcohol consumption, dietary information, herbal remedies and vitamin K intake, history of anticoagulant therapy, and current INR value.

The patient's genetic information may include genetic information about the patient, and how that patient having that genetic information might respond to the anticoagulant agent. For example, genetic variants of enzymes CYP2C9 and VKORC1 have been shown to affect an individual's response to warfarin. Such variants may predict warfarin maintenance dose and identify individuals predisposed to unstable anticoagulation during the initiation of the warfarin therapy.

The patient's dietary information may include information as to whether the patient is consuming vitamin K rich food items. For example, since anticoagulant warfarin acts in the vitamin K cycle by inhibiting vitamin K epoxide reductase (VKOR) and thereby reducing the regeneration of vitamin K, consumption of vitamin K rich food items may affect the effectiveness of the anticoagulant agent. These food items may include green leafy vegetables, soybeans and canola oil. Additional vitamin K intake, through vitamin supplements and/or herbal remedies should also be monitored if applicable. The information about the diet may be collected as an amount of vitamin K consumed by the patient. The amount of vitamin K consumed could be calculated by the patient, or by the system after the patient provides information about his diet. Certain beverages, (for example, cranberry juice) may increase the effect of the anticoagulant agent, leading to bleeding problems. Dietary information may include information about consumption of these types of food items.

The patient information may also include history of anticoagulant therapy. For example, if a patient has previously taken an anticoagulant agent, information as to the dosage and the effect of that dosage on that patient may be included in the patient's history of anticoagulant therapy. This information, along with the patient's current INR value may be used for determining maintenance dosage.

The system 10 also comprises the INR tester 16 for obtaining the patient's blood INR value. The INR tester 16 may be a blood test at a laboratory or a home-based INR testing device. A laboratory test may be considered to be slightly more accurate, but home-based INR testing offers the convenience of testing at home. The added convenience may encourage more frequent monitoring and possibly quicker dosage adjustments. A combination of home and laboratory testing may also be recommended to provide optimal care.

The patient information may be provided to patient portal 12 automatically or manually. The patient portal 12 may receive patient information from the patient via the patient portal input device 34. For example, the patient may perform a home INR test to obtain a test result, and provide the test to the patient portal 12 via the patient portal input device 34. In other embodiments, the patient portal 12 may also receive patient information by retrieving the information from the patient portal memory 32. The patient portal 12 may receive patient information partially from the patient portal memory 32, and from the patient. Patient information may also be received via the patient portal communication interface 36. For example, a health care provider may provide the patient portal 12 with patient information over the Internet.

The system 10 also comprises the case repository 14. In the embodiment as shown the case repository 14 is located remotely from the patient portal 12 and accessible through a server 18. The case repository 14 is connected to the patient portal 12 such that at least some of the contents of the case repository 14 are accessible to the patient portal 12.

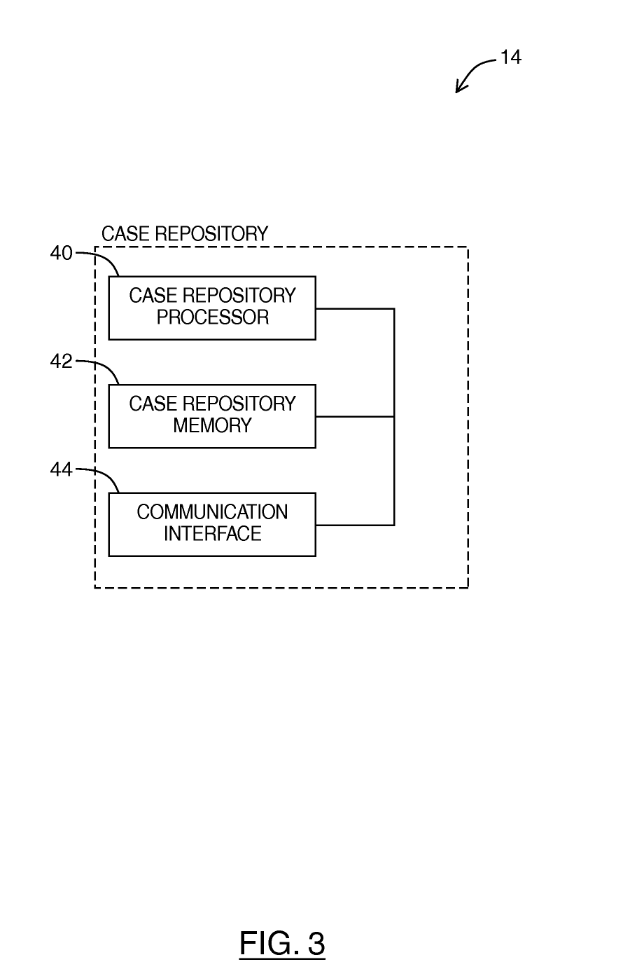

Referring to FIG. 3, the case repository 14 has a case repository processor 40, a case repository memory 42, and a case repository communication interface 44. In some embodiments, the case repository processor 40 and the patient portal processor 30 may be implemented by a same processor. Similarly the case repository memory 42 and the patient portal memory 32 may also be implemented by a same memory.

The case repository communication interface 44 could be a cellular modem, a wireless modem, a wired interface including a USB interface or a combination of software and hardware interface capable of facilitating communication to at least one other component in the system. In the embodiment as shown, the case repository communication interface 44 facilitates communication with the server 18.

The case repository 14 contains at least one previous case in the case repository memory 42. In some embodiments, the case repository may contain a plurality of previous cases stored in the case repository memory 42. The case repository memory may be organized using database software to optimize storage and searching capability.

The previous cases on the case repository may be accessed and modified by a health care provider, a patient, or an administrator. They may also be accessed and modified by another software system. Health care providers may also assess the quality of the cases in the repository.

Each previous case contains previous patient information about a previous individual who has previously been administered anticoagulant therapy. In some cases, the previous individual may be the current patient. The previous patient information may contain at least one factor affecting the previous patient's reaction to anticoagulant therapy. Similar to the patient information associated with the current case stated hereinabove, the previous patient information may include one or more of: age, weight, height, ethnicity, use of liver enzyme inducing agents, sulfonamide antibiotics, macrolide antibiotics, statins, antiplatelet medications, smoking, genetic information, quantity of alcohol consumption, frequency of alcohol consumption, dietary information, herbal remedies and vitamin K intake, history of anticoagulant therapy, and current INR value.

The previous patient information need not be the same as the patient information for the current patient. That is, the factors present in the previous case may be different from the factors in the current case. For example, it is possible that the previous patient information may not contain genetic information since it may be not have been practical to perform genetic testing when the previous case was treated. It is possible that a previous case and a current case may not share a common factor.

Each previous case also contains at least one solution to that case. Some of the previous cases may contain exactly one solution for each case. The solution may be the dosage of anticoagulant agent prescribed for the previous patient. The solution may also be dietary adjustment, or adjustment to any of the factors.

In the embodiment as shown, the patient portal processor 30 and/or the case repository processor 40 is programmed for selecting at least one relevant case similar to the current case from the previous cases stored in the case repository memory 42. In other embodiments, any processor with access to the patient information associated with the current case and the previous cases in the case repository may be programmed to perform this function.

A similarity metric is used to determine similarity between the current case and each previous case. The similarity metric quantifies the degree of similarity between each previous case and the current case. This permits ranking of each previous case based on that case's similarity to the current case in comparison to other previous cases. The similarity metric also permits comparison of two previous cases, which do not share like factors. For example, a previous case P1 does not contain genetic information, a previous case P2 does not contain dietary information, and the current case contains genetic information and the dietary information. To determine whether the previous case P1 is more similar to the current case than the previous case P2, a similarity metric may be utilized.

Implementation of the similarity metric may comprise assigning relative weights of importance to various factors that may affect an individual's reaction to anticoagulant agent. For example, to quantify the degree of similarity between one of the previous cases and the current case, the similarity metric may assign a local similarity value for each of the factors based on the similarity between the factors. However, some of the factors found in the current case might not be available in the previous case for comparison. Similarly, some of the factors found in the previous case might not be available in the current case for comparison.

It is also possible that both the current case and the previous case might not have certain factors recorded to determine similarity. To account for such situations, the similarity metric may assign a first default value for situations where only one of the cases has information about a factor and a second default value for situations where both cases do not have information about a factor. Using the default value permits the similarity metric to take advantage of the relative weight of importance for the factors in the calculation described below.

After assigning local similarity values for each factor, the local similarity values will then be multiplied by the weight assigned to the corresponding factor to obtain a weighted local similarity value for each factor. The local similarity values may be added to obtain a global similarity value for that previous case. The global similarity values between different previous cases could be used to determine which of the previous cases are more similar to the current case.

In some embodiments, the similarity metric may further comprise a similarity index, which might be applied prior to calculating the global similarity value. The similarity index encourages comparison between cases with certain designated factors. Upon receiving the current case with patient information comprising several factors, the similarity index may be applied to previous cases with a certain number of like factors. For example, if the age of the patient in the current case is between 40-50, and the patient is male, the similarity index with age and gender as designated factors will filter out previous cases that do not share similar values these designated factors. The similarity metric may then calculate the similarity of remaining previous cases that are not filtered out by the similarity index. By using the similarity index prior to calculating the similarity value, only previous cases having the designated factors will be compared. This reduces the number of previous cases for comparison and may reduce processing requirements and improve response time. The designated factors for the similarity index may also be selected to improve accuracy of the similarity metric.

The similarity metric may also be refined over time using various knowledge acquisition methodologies. Knowledge acquisition may be done manually or automatically. For example, the similarity metric may be modified manually based on outcomes of scientific research. In another example, empirical data may be automatically gathered by the case repository 14 and used to modify the similarity metric automatically. Modifications to the similarity metric may include modifying the relative weight of importance assigned to the factors.

While one embodiment of the similarity metric has been described hereinabove, modifications to the described similarity metric and/or entirely new similarity metric may also be used to measure the similarity of at least one of the previous cases to the current case in other embodiments.

At least one of the patient portal processor 30 and the case repository processor 40 may be programmed to use the similarity metric to select at least one relevant case from the previous cases stored in the case repository memory 42. In some embodiments the at least one relevant case may be a single most similar case as determined by the similarity metric. This may be of particular importance if an end-user of the system 10 is the patient. By selecting the most similar case, the system 10 may relieve the patient of the need to decide between a plurality of cases that are relevant. However, in other embodiments, the at least one relevant case may comprise a plurality of cases. For example, if the end-user of the system 10 is a health-care provider, the system 10 might provide him with a short-list of similar cases for analysis and selection. In other embodiments, the system 10 may provide the patient with the short-list of cases.

Each of the previous cases stored in the case repository memory 42 has at least one solution associated with that previous case. The at least one solution may be the dosage of anticoagulant agent. The at least one solution may also comprise adjustments to various factors such as adjustments to vitamin K intake, or alcohol intake. The solution may also comprise information as to the number of times that solution had been applied.

A proposed solution for the current case comprises one of the at least one solution to the relevant previous case. Depending on the similarity between the selected relevant previous case and the current case, the proposed solution may be further modified. The modifications may be based on differences in factors between the current case and the selected relevant previous case. The modification of the proposed solution is intended to better adapt the solution to the current case, and may be based on rules and guidelines applied in the industry related to administering the anticoagulant agent. Modification of the proposed solution may comprise best practice industry guidelines/rules for warfarin management. In some situations, it is also possible that the processor is programmed to seek a health care provider's advice. In such cases, the modification may be based on the input provided by the health care provider. In other embodiments, input for from the patient may also be quested by the system 10. There may be more than one possible modification to achieve a desired solution. For example, a decrease in warfarin dose may have the same effect as reducing alcohol consumption. In such situations, the patient input may requested, and used by the system 10.

The proposed solution is provided to the patient portal output device 38 on the patient portal 12 for application to the current case.

After applying the solution to the current case, the patient may use the INR tester 16 to measure his blood INR value after the solution is applied. Results from this test may be provided to the patient portal 12 and may be used to determine if the desired INR value range has been achieved. If it is determined that the desired INR value range has not been achieved, then the system 10 may repeat the process of selecting at least one relevant case and providing another proposed solution as described herein above. If the desired INR value range has been achieved, the system 10 may retain the proposed solution that is applied, and patient information related to the current case as a previous case for future cases. Adding solutions and related cases to the case repository 14 may improve the quality of the answers provided by the system 10.

The system 10 also comprises a healthcare provider portal 20. The health care provider portal is accessible to at least one health care provider. The term “health care provider” used herein includes physicians, pharmacist, lab technicians, or any other qualified individual that may wish to access the case repository 14 and/or the patient portal 12.

The health care provider portal 20 is accessible to a health care provider who may assist in determining a final proposed solution, which may include prescribed dosage of warfarin, for the patient. Inclusion of the health care provider's opinion might be desirable in situations where the most similar previous case to the current case is notably different from the current case, or if there are no similar previous cases. In such situations, an opinion of the health-care provider may be requested through the health care provider portal 20. Additionally, the health care provider may monitor the patient's current dosages for safety reasons. Health care providers may use the health care provider portal 20 to access cases in the repository, contribute cases to the repository, and/or assess the quality of the cases in the repository.

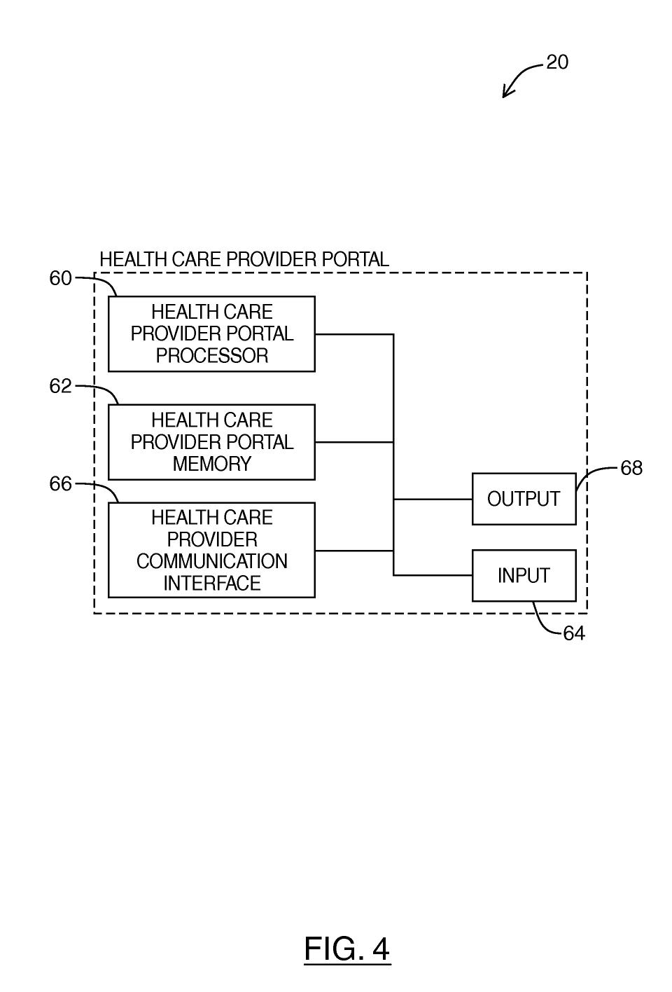

Referring to FIG. 4, the health care provider portal 20 comprises a health care provider portal processor 60, health care provider portal memory 62, a health care provider portal communication interface 66, a health care provider portal input device 64 and a health care provider portal output device 68. The components of the health care provider portal 20 are operatively connected to one another.

The health care provider processor 60 may be located remotely from the health care provider portal memory 62 such that the processing of information is performed remotely from the health care provider portal memory 32. For example, the health care provider portal 20 may be a web-browser and the health care provider portal processor 60 may be located remotely over a wide area network. Similarly, the patient portal memory 62 may be located remotely, and data from the patient portal memory 62 may be transmitted through the health care provider portal communication interface 66 prior to processing.

The health care provider portal output device 68 may be a display device such as a screen capable of displaying information. It might also be a printer that is capable of printing out information such that a secondary copy of the information may be produced for future reference. The health care provider portal output device 68 may be any other hardware, software or a combination of hardware and software that is capable of communicating information to a user of the health care provider portal 20.

The health care provider portal communication interface 66 may be a cellular modem, a wireless modem, a wired interface including a USB interface or a combination of software and hardware interface capable of facilitating communication to at least one other component in the system. In the embodiment as shown, the health care provider portal communication interface 66 facilitates access to the Internet for communication with the server 18 and the patient portal 12.

The health care provider portal 20 further comprises a health care provider portal input device 68 to input information to the health care provider portal 20 to be stored in health care provider portal memory 62 and/or to be processed by the health care provider portal processor 60. Some exemplary input devices include keypads, keyboards and touch sensitive surfaces. The health care provider portal input device 68 may be used to input information into the patient portal 12 through the health care provider communication interface 66 and the Internet.

The system 10 also comprises the server 18. The server 18 facilitates communication between the patient portal 12, health care provider portal 20, and the case repository 14. The server 18 is accessible through the Internet, and acts as a central hub for communication. In embodiments where there are numerous patient portals and health care provider portals, the server 18 may facilitate more efficient communication between the components of the system 12. In some embodiments, the patient portal might be connected directly to the case repository without using the sever 18.

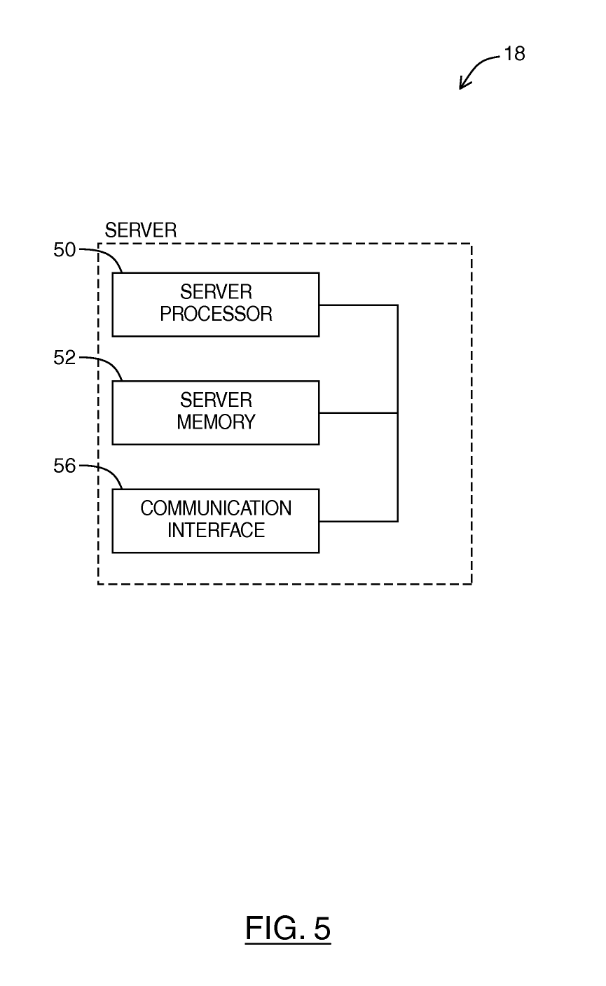

Referring to FIG. 5, the server 18 comprises a server processor 50, a server memory 52, and a server communication interface 56. The server processor 50 is programmed to facilitate communication between the case repository 14, the patient portal 12, and the health care provider portal 20. The server memory 52 may be used for caching purposes.

The server communication interface 56 may be a cellular modem, a wireless modem, a wired interface including a USB interface or a combination of software and hardware interface capable of facilitating communication to at least one other component in the system. In the embodiment as shown, the server communication interface 56 facilitates access to the Internet.

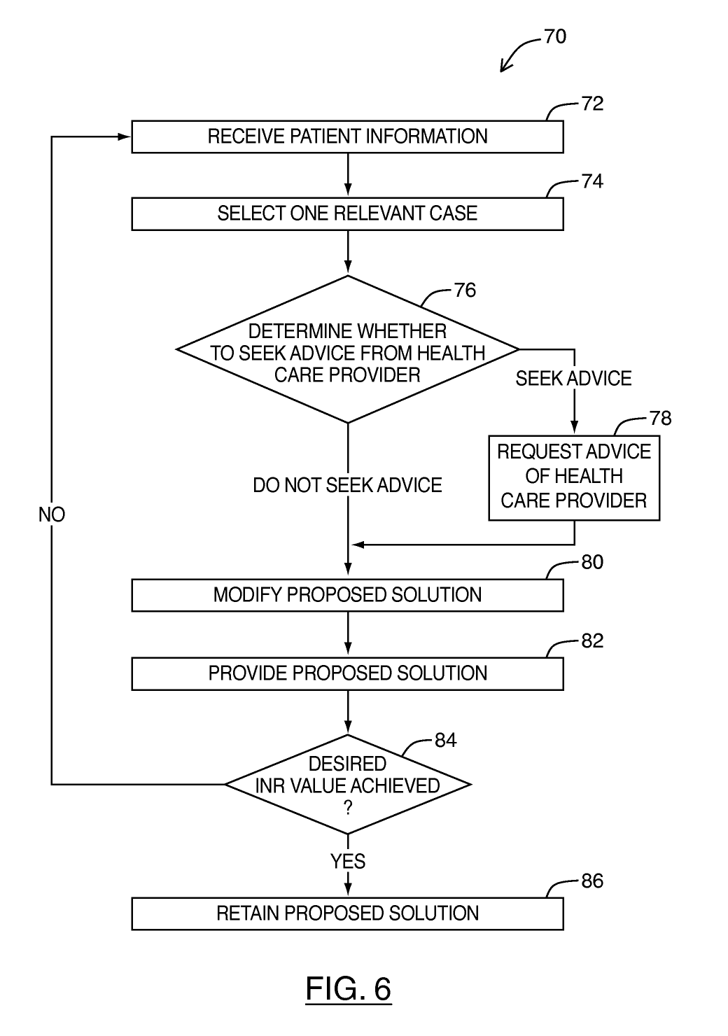

Referring to FIG. 6, provided therein is a computer-implemented method 70 for facilitating patient-managed anticoagulant therapy using a processor and a memory according to one exemplary embodiment.

The method 70 begins at step 72 wherein the processor receives patient information. The patient information may be received from a patient, a health care provider, the memory connected to the processor, or a system connected to the processor as described herein above. The patient information received by the patient portal 12 may include various factors that may affect the patient's reaction to anticoagulant therapy similar to the patient information as described in system 10 herein above.

The method 70 proceeds to step 74 wherein the processor selects at least one relevant case similar to the current case from a case repository. The case repository may be similar to the case repository 14 as described herein above. As described above, the case repository contains at least one previous case about a previous individual who has previously been administered anticoagulant therapy. Each previous case also contains at least one solution to that case. The at least one solution may be the dosage of anticoagulant agent for the previous patient exhibiting the factors as recorded in the previous case.

Selecting at least one relevant case similar to the current case from the previous cases stored in the case repository may further comprise determining similarity between the current case and each previous case. To determine similarity, a similarity metric, similar to the similarity metric described above may be used. Once at least one relevant case is selected, the method 70 proceeds to step 76.

At step 76, the method 70 determines whether it is necessary to seek advice from a health care provider. The health care provider's advice may be sought in situations where the most similar previous case to the current case is notably different from the current case. The health care provider's advice may also be sought in other scenarios wherein the patient information suggests that it might be desirable to do so. For example, it may be possible that the patient information includes a factor, which requires attention of a health-care provider. In some embodiments, the health care provider may monitor the patient's current dosages and decide to provide advice without being prompted by the method 70. If the method 70 determines that health care provider advice should be requested, the method 70 proceeds to step 78. Alternatively, the method 70 proceeds to step 80.

At step 78, the method 70 requests advice of a health care provider. This may be accomplished using a health care provider portal 20 as described hereinabove. This may also be accomplished by direct communication with the health care provider. Once advice of a health care provider is received, the method 70 proceeds to step 80.

At step 80, the method 70 may modify the proposed solution, which is the at least one solution in the at least one relevant case. The modifications may be based on at least one difference in factors between the current case and the selected relevant previous case. The modifications may also be based on the advice of the health care provider if provided in step 78. The modification of the proposed solution is intended to better adapt the solution to the current case, and may be based on rules and guidelines applied in the industry related to administering the anticoagulant agent. Modification of the proposed solution may comprise best practice industry guidelines/rules for warfarin management. Once the proposed solution is modified, or it is decided that no modifications are necessary, the method 70 proceeds to step 82.

At step 82, the method 70 provides the proposed solution to a patient for application to the current case.

At step 84, the method 70 determines whether the desired INR value range has been achieved. This step is typically performed after the proposed solution has been given the opportunity to affect the patient's INR value. The patient's INR value can be measured using an INR tester similar to the INR tester 16 described above.

If the desired INR value range has not been achieved, the method 70 returns to step 72. If the desired INR value range has been achieved, the method 70 the proceeds to step 86.

At step 86, the method 70 retains the proposed solution and associated patient information about the current case as a previous case for future cases.

While the steps of the above method 70 have been described sequentially hereinabove, it should be noted that sequential performance of the steps may not need to occur for successful implementation of the method. As will be evident to one skilled in the art, rearranging the order of performing the steps, performing the steps in parallel, or omitting performance of some steps may be possible without abandoning the essence of the exemplary embodiments.

While certain features of the exemplary embodiments have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

1. A computer implemented method for patient-managed anticoagulant therapy using a processor and a memory, the method comprising:
a) receiving patient information associated with a current case, the patient information including at least one current factor affecting patient reaction to anticoagulant therapy;
b) selecting at least one relevant case similar to the current case from at least one case repository, the case repository comprising at least one previous case; each previous case having at least one previous factor affecting patient reaction to anticoagulant therapy and at least one solution; and
c) providing the at least one solution of the at least one relevant case for application to the current case.

2. The method of claim 1, wherein at least one of the current factor and the previous factor comprises at least one of the following factors: age, weight, height, ethnicity, use of liver enzyme inducing agents, sulfonamide antibiotics, macrolide antibiotics, statins, antiplatelet medications, smoking, genetic information, quantity of alcohol consumption, frequency of alcohol consumption, dietary information, herbal remedies and vitamin K intake, history of anticoagulant therapy, and current INR value.

3. The method of claim 1, further comprising applying a similarity metric to determine similarity of each previous case to the current case.

4. The method of claim 3, wherein the similarity metric comprises assigning a relative weight of importance to each of the at least one current factor in the current case and each of the at least one previous factor in each previous case.

5. The method of claim 3, further comprising modifying the similarity metric based on at least one of empirical data, expert opinion, and a knowledge acquisition algorithm.

6. The method of claim 3, wherein the at least one relevant case from the at least one case repository comprises one previous case, that one previous case determined as being most similar to the current case using the similarity metric.

7. The method of claim 1, further comprising seeking input from a health care provider in predetermined situations.

8. The method of claim 1, further comprising modifying the at least one solution of the at least one relevant case prior to applying that solution to the current case.

9. The method of claim 8, wherein the at least one solution is modified based on at least one of best practice guidelines for warfarin management, input from a health care provider, and input from a patient.

10. The method of claim 1, further comprising retaining the at least one solution provided for application to the current case.

11. The method of claim 1 wherein selecting the at least one relevant case is based on input from at least one of a health care provider and a patient.

12. A physical computer-readable medium upon which a plurality of instructions are stored, the instructions for performing the steps of the method as claimed in claim 1.

13. A system for facilitating patient-managed anticoagulant therapy comprising:
a) at least one patient portal for receiving patient information associated with a current case, the at least one patient portal including at least one patient portal processor, a patient portal memory, and at least one output device, and the patient information including at least one current factor affecting patient reaction to anticoagulant therapy;
b) at least one case repository connected to the patient portal, the at least one case repository including a case repository processor and a case repository memory, the case repository memory containing at least one previous case, each previous case including at least one previous factor affecting patient reaction to anticoagulant therapy and at least one solution;
wherein at least one of the patient portal processor and the case repository processor is programmed for selecting at least one relevant case similar to the current case from the at least one previous case in the case repository memory, and providing the at least one solution of that at least one relevant case to the at least one output device of the patient portal for application to the current case.

14. The system of claim 13, further comprising at least one INR tester, wherein the patient information received at the patient portal includes at least one result of the at least one INR tester.

15. The system of claim 13, further comprising a healthcare provider portal comprising at least one health care provider processor and at least one health care provider memory connected to the patient portal and the case repository.

16. The system of claim 13, wherein the at least one of the patient portal processor and the case repository processor is programmed for seeking input from a health care provider in predetermined situations.

17. The system of claim 13, wherein the case repository is located remotely from the patient portal.

18. The system of claim 13, wherein at least one of the current factor and the previous factor comprises at least one of the following factors: age, weight, height, ethnicity, use of liver enzyme inducing agents, sulfonamide antibiotics, macrolide antibiotics, statins, antiplatelet medications, smoking, genetic information, quantity of alcohol consumption, frequency of alcohol consumption, dietary information, herbal remedies and vitamin K intake, history of anticoagulant therapy, and current INR value.

19. The system of claim 13, wherein the at least one of the patient portal processor and the case repository processor is programmed for using a similarity metric to determine similarity of each previous case to the current case.

20. The system of claim 19, wherein the similarity metric comprises assigning a relative weight of importance to each of the at least one factor in the current case and each of the at least one factor in each previous case.

21. The system of claim 19, wherein the similarity metric is modified based at least one of empirical data, expert opinion, and a knowledge acquisition algorithm.

22. The system of claim 19, wherein the at least one relevant case from the at least one case repository comprises one previous case, that one previous case determined as being most similar to the current case using the similarity metric.

23. The system of claim 13 wherein the at least one of the patient portal processor and the case repository processor is programmed for modifying the at least one solution of the at least one relevant case prior to applying that solution to the current case.

24. The system of claim 22 wherein at least one solution is modified based on at least one of best practice guidelines for warfarin management, input from a health care provider, and input from a patient.

25. The system of claim 23 wherein the at least one of the patient portal processor and the case repository processor is programmed for retaining the at least one solution provided for application to the current case.

26. The system of claim 23 wherein selecting the at least one relevant case is based on input from at least one of a health care provider and a patient.
